(19) United States
(12) Patent Application Publication
(10) Pub. No.: US 2025/0135478 A1
(43) Pub. Date: May 1, 2025

(54) Electronic Pressurised Fluid Dispensing Gun with Automatic Locking Mechanism

(71) Applicant: SAMOA Industrial S.A., Gijón (ES)

(72) Inventors: Alberto Gonzalez Moratiel Alvarez, Madrid (ES); Luis Miguel Alvarez Pelaez, Siero (ES); Marcos Torre Gomez, Gijon (ES); Ivan Fernandez Bigotes, Gijon (ES)

(21) Appl. No.: 18/834,903

(22) PCT Filed: Nov. 3, 2022
(86) PCT No.: PCT/IB2022/060581

§ 371 Date: Jul. 31, 2024

(30) Foreign Application Priority Data
Feb. 1, 2022 (ES) P202230077

(51) Int. Cl. B05B 9/04; B05B 12/00; B05B 12/08

(52) U.S. Cl. CPC B05B 9/0403; B05B 12/002; B05B 12/085

(57) ABSTRACT

This invention relates to an electronic pressurised fluid dispensing gun equipped with a volume metering chamber, a control valve, an automatic locking mechanism controlled by an electronic system which may have wireless communication and a wireless battery charging system. The volume measurement chamber is located downstream of the control valve and outside the pressure line in order to gain more accurate measurements as it is not influenced by the pressure of the fluid and its movements generated by pressure changes or water hammer. The automatic locking mechanism is located at the bottom of the gun such that it does not interrupt the flow of pressurised fluid so that the fluid inlet and outlet through the gun are on the longitudinal plane of the gun and whose automatic locking mechanism does not allow dispensing unless a new dispense command is validated in the gun's electronics module. This automatic locking mechanism will act independently of the trigger stroke, allowing the flow rate to be regulated without the need to lock the trigger in an extreme position.

### PURPOSE OF THE INVENTION

This invention relates to a pressurised fluid dispensing gun with a flow metering element, a control valve, an automatic locking mechanism controlled by an electronic system which may include wireless communication and a rechargeable battery power supply system. The flow measuring element is placed downstream of the control valve and outside the pressure line in order to gain more accurate measurements as it is not influenced by the pressure of the fluid and its movements generated by pressure changes or water hammer. The automatic locking mechanism is located at the bottom of the gun in such a way that the fluid inlet and outlet through the gun are on the same longitudinal plane of the gun, so that it does not interrupt the flow of pressurised fluid. This locking mechanism enables, with minimum energy consumption, the flow of fluid to be automatically stopped when a quantity of fluid is reached. This quantity of fluid would have been previously set by the user in the electronics module integrated in the gun itself. Once the pre-set quantity has been reached, regardless of whether the trigger is held down, the mechanism will automatically close the valve incorporated in the fluid dispensing gun by means of a bi-articulated connecting rod which is actuated by the trigger and connects the valve actuation piston with a slide. In addition, this mechanism will prevent fluid being dispensed unless a new dispense command is validated in the gun's electronics module.

### FIELD OF APPLICATION OF THE INVENTION

This invention is to be applied within the industrial sector of guns for the dispensing of pressurised fluids, such as hydrocarbons, chlorinated hydrocarbons, acids, bases and other chemical products used in industrial processes.

### BACKGROUND TO THE INVENTION

Most of the electronic pre-selection metering guns for pressurised fluid dispensing on the market have mechanisms that do not guarantee the traceability of the quantities dispensed nor are they optimised to allow their operation under minimal force. The type of mechanism present in these guns generally serves the sole function of holding the trigger in an extreme position as well as having manual mechanical position locking to keep the valve open, but always allows fluid to be dispensed. In these mechanisms, as the trigger needs to be held in an extreme position during dispensing, it is not possible to regulate the flow rate during dispensing. Other types of guns equipped with a mechanism that guarantees the traceability of the quantities dispensed have more voluminous mechanisms that do not optimise the mechanism's actuating force and also interfere with the fluid outlet connection, forcing the fluid outlet to be off-centre with respect to the gun handle, which has a negative impact on the ergonomics of the gun. We are unaware of the existence of a fluid dispensing gun where the flow metering element is located downstream of the control valve and outside the pressure line and where the automatic locking mechanism is located at the bottom of the gun such that the fluid inlet and outlet through the gun are on the same longitudinal plane of the gun such that it does not interrupt the flow of fluid under pressure and such automatic mechanism does not allow dispensing unless a new dispense command is validated in the gun's electronics module. This automatic mechanism also allows the dispensing control to be operated independently of the trigger stroke, allowing the flow rate to be regulated without the need to lock the trigger in an extreme position.

### DESCRIPTION OF THE INVENTION

This mechanism is to be applied in portable electronic pre-selection guns for the dispensing of pressurised fluid in industry. The gun allows dispensing only if the operator has validated an order in the electronics module, which can also have wireless communication in order to guarantee the traceability of all dispensed quantities. Once a dispense command is validated, the valve locking mechanism will be responsible for performing the valve closure when the amount of fluid set on the gun by the user is reached.

The electronic gun consists of:
a fluid inlet connection (1),
a handle (2) for easy handling,
an electronic control interface (3) for managing and inputting the quantities of fluid to be dispensed, which may include wireless communication for connection with other management systems external to the gun.
a wireless battery recharging system comprising the receiver (29) and the charging station (28); and a manually operated trigger (5) for opening and closing the fluid flow valve (6),
a measuring chamber (8) for measuring the volume of fluid transferred and communicating it to the electronics module (9) and,
an outlet connection (4) to which a nozzle extension (7) is attached to prevent fluid dripping and to direct the fluid flow to the outlet.

The valve (6) allows the passage of fluid between the inlet (1) and outlet (4), passing on its way through the measuring chamber (8) in charge of registering the transferred fluid and communicating it to the electronics module (9). The O-ring (20) mounted on the valve (6) is responsible for closing the passage of fluid.

The automatic valve locking mechanism consists of:
a valve (6),
a connecting rod (10),
a pin (11) that connects the valve (6) to the connecting rod (10) and slides along the groove (10a),
a slide (12),
a pin (13) connecting the connecting rod (10) to the slide (12),
a spring (14),
a cam pawl (15)
a torsion spring (30) and,
a solenoid (16) whose stem (16a) moves linearly by retracting and extending when receiving an electrical signal from the electronics module (9).

The solenoid (16) is controlled by the electronics module (9) and operates with minimum energy consumption thanks to the special design of the cam pawl (15), which is kept in contact with the slide (12) by the torsion spring (30), and the connecting rod (10) which make up the mechanism and are responsible for reducing the force exerted by the valve (6) and reducing the force received by the stem (16a).

As shown in FIG. 5, once the quantity to be dispensed has been entered, the trigger (5) interacts with the locking mechanism to move the valve (6) and allow the fluid to pass through the channel (18) from the inlet connection (1) to the outlet (4) of the gun.

After passing through the valve, the fluid passes through the metering chamber (8) which registers the volume transferred and this is recorded by the electronic control module (9).

Once the quantity of fluid set in the electronics module (9) has been reached, a signal is sent to the solenoid (16) which retracts the stem (16a) and then the locking mechanism closes the valve (6), stopping the flow of fluid as shown in FIG. 4. This will occur regardless of the position of the trigger (5) and will prevent further dispensing until a new amount of fluid is entered and validated at the control interface (3). If a dispense command is not activated, even if the trigger (5) is actuated, valve opening will not occur due to the design of the locking mechanism. This ensures that all dispensing is recorded and guarantees traceability.

### DESCRIPTION OF THE DRAWINGS

In order to supplement the description herein and to assist in a better understanding of the features of the invention, a set of drawings is attached hereto as an integral part of the description, which for illustrative purposes, and without limitation, depicts the following:

FIG. 1 shows an isometric view of the electronic fluid dispensing gun. [symbol] shows a

FIG. 2 longitudinal section of the gun and a cross section “A-A” to visualise the state of the locking mechanism at rest without an active dispense command.

FIG. 3A shows an isometric view of the locking mechanism in the disengaged position.

FIG. 3B shows an isometric view of the locking mechanism in the activated position.

FIG. 4 shows a longitudinal section of the gun and a cross section “B-B” to display the status of the locking mechanism with manually depressed trigger and closed valve.

FIG. 5 shows a longitudinal section of the valve locking mechanism in the active pre-selection position with the valve open.

FIG. 6 shows a longitudinal section of the gun displaying the status of the locking mechanism, in valve open position, with trigger locked without manual intervention.

FIG. 7 shows an isometric view of the gun mounted on the wireless charging cradle.

FIG. 8 shows an isometric view of the main components of the wireless charging system.

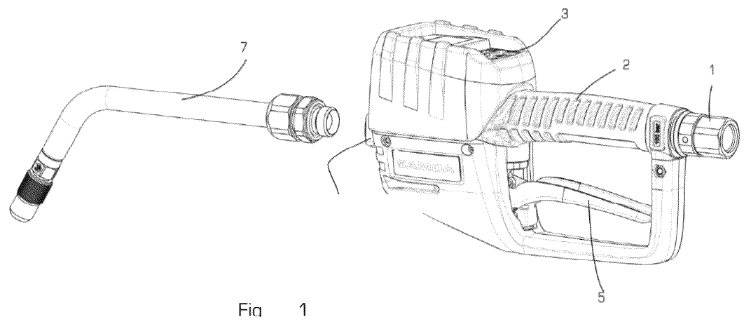

### PREFERRED IMPLEMENTATION OF THE INVENTION

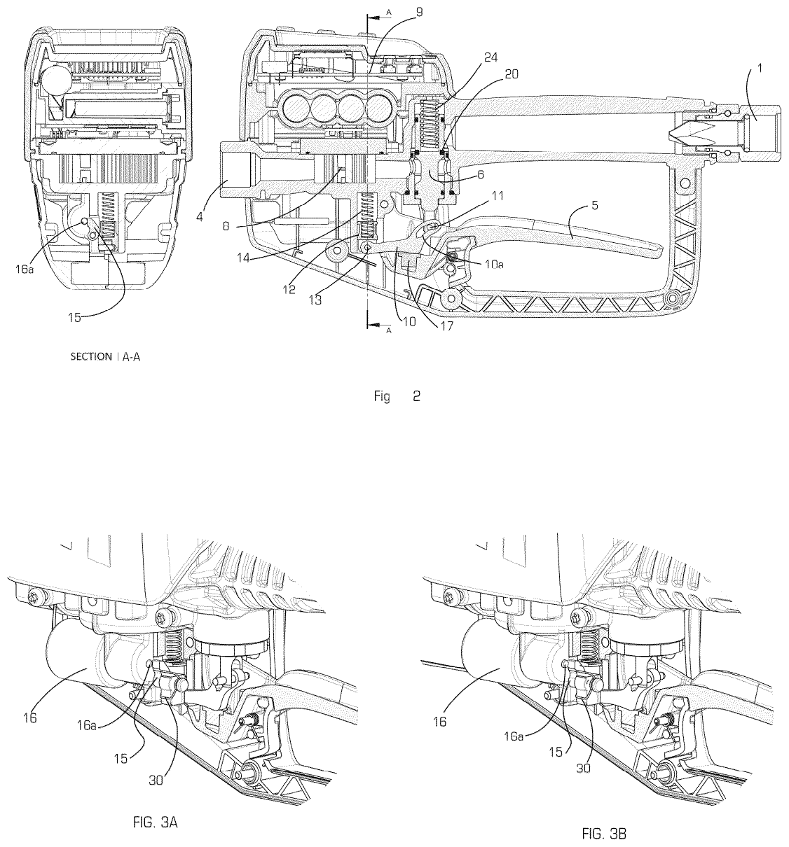

FIG. 2 shows a section of the gun in the state in which a dispense command has not been entered at the control interface (3) and therefore no fluid dispensing is enabled despite the trigger (5) being pulled. Actuating the trigger (5) causes the stop (17) inserted in the trigger to move the connecting rod (10). The connecting rod (10) is articulated at one end with the slide (12) by means of the pin (13) and is guided at the other end by means of the groove (10a) with the pin (11) attached to the valve (6). The special design of the connecting rod (10) generates different vertical forces on the pins (11) and (13). The force generated on the pin (11) is less than the retention force of the spring (24) so that the valve (6) does not move, while the force on the pin (13) is greater than the force exerted by the spring (14) so that the slide (12) starts to move and the valve (6) remains immobile. The slide (12) moves freely when it comes into contact with the pawl (15) by moving it. FIG. 4 shows the final position of the mechanism with the trigger (5) pressed down, the slide (12) moved to the upper point by the movement of the connecting rod (10) and the valve (6) in the closed position preventing the passage of fluid.

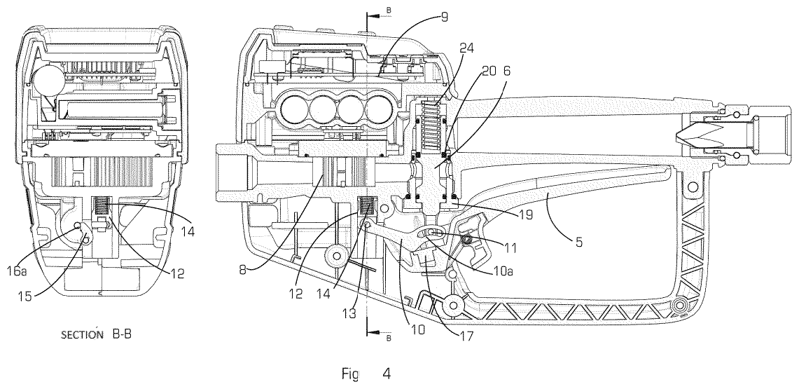

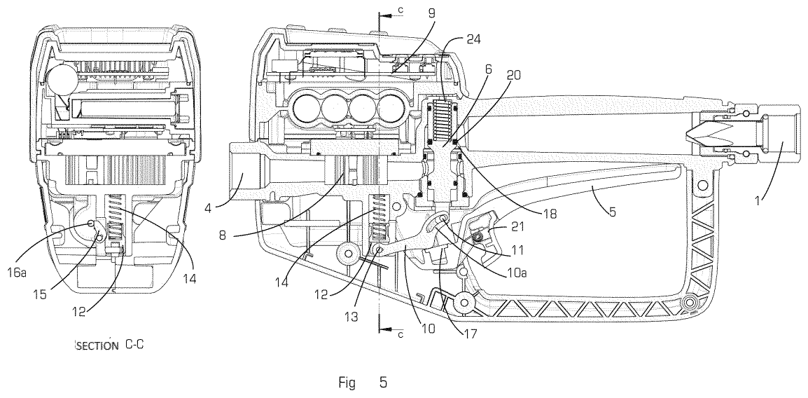

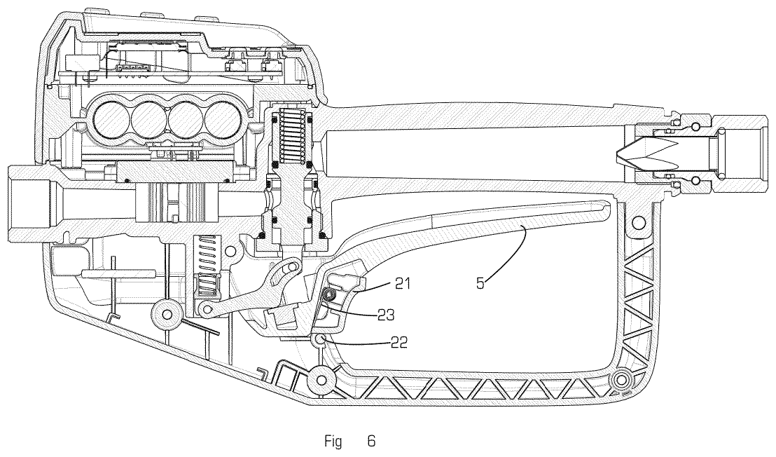

Starting from the state described in FIG. 2, a state in which fluid dispensing is prevented, a dispensing activation from the electronics module (9) causes the extension of the solenoid stem (16a) shown in FIG. 3B. The extension of this stem (16a) prevents the ratchet (15) from turning anticlockwise. In this situation, as can be seen in FIG. 5, pressing the trigger (5) causes the stop (17) to exert force on the connecting rod (10), which in turn exerts force on the slide (12) and on the pin (11) that connects to the valve (6). The slide (12) exerts force on the pawl (15) which is prevented from moving when it comes into contact with the stem (16a) of the solenoid (16). The connecting rod (10) hinged on the slide (12) is prevented from moving vertically at the point of articulation (13) with the slide (12), so that the only possibility of movement of the connecting rod is the connecting pin (11) with the valve (6). The increase of the actuation force on the trigger (5) produces the compression of the spring (24) of the valve (6), generating the displacement of the trigger (5) in an upward movement and the opening of the valve (6), that moves towards its upper point. The movement of the valve (6) allows fluid to pass through the channel (18) towards the chamber (8) and then to the outlet connection (4). The volume of fluid transferred through the measuring chamber (8) is recorded by the electronics module (9). The trigger (5) can be held in manual operation or can be locked by pressing the button (21). FIG. 6 shows the locking of the trigger (5) by means of the button (21) which is actuated at the same time as the trigger (5) is lowered until contact is made between the locking button (21) and the pin (22) inserted in the body of the gun. Once this position has been reached, the trigger can no longer be manually operated and the valve will remain in the previously actuated fluid flow position. To unlock the trigger, simply pull the trigger (5) slightly and the torsion spring (23) will return the locking button to its initial rest position.

Once the transferred volume reaches the user-set amount, the electronics module feeds the solenoid (16) for a time of less than 100 milliseconds by retracting its stem (16a) as shown in FIG. 3a. The retraction of the rod (16a), previously in contact with the pawl (15), allows the pawl to turn anticlockwise and the slide (12), whose movement was limited by the pawl (15), is no longer prevented from moving in a linear direction. In this situation, due to the peculiar design of the connecting rod (10) and the different stiffness of the slide spring (14) and valve spring (24), the slide spring (14) is compressed while the valve spring (24) is extended. FIG. 4 shows how the valve spring (24) pushes the valve (6) in its extension until it stops against the seal holder (19). The displacement of the valve (6) causes the connecting rod (10) to slide in the groove (10a) through the pin (11) of the valve, with this movement generating the vertical ascent of the slide (12) articulated in the pin (13) with the connecting rod while compressing the slide spring (14). The downward movement of the valve (6) closes the passage of the fluid (18) via the seal (20) and thus stops dispensing. The cessation of force on the trigger (5) causes a return to the initial state described in FIG. 2.

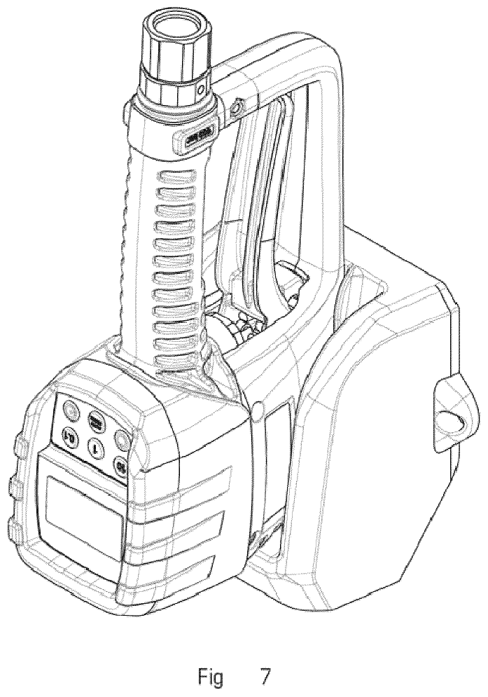

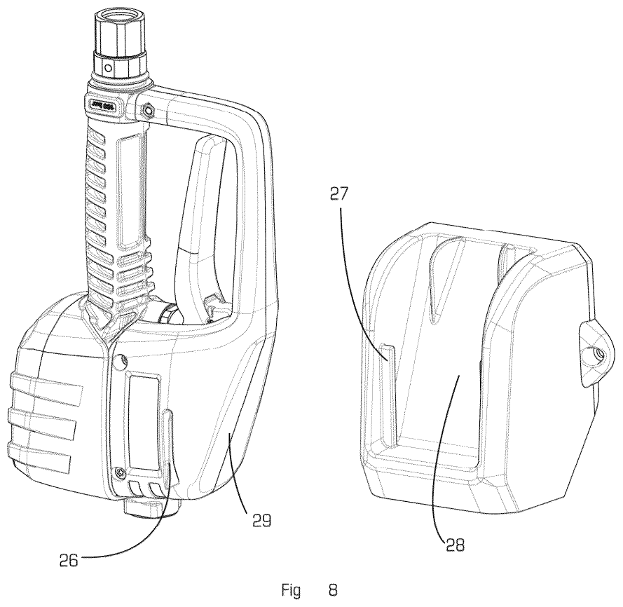

FIG. 7 shows an assembly of the Electronic Fluid Dispensing Gun mounted on the wireless charger. FIG. 8 shows all components of the wireless charging system identified. The Electronic Fluid Dispensing Gun clamping guides (26) are used to hold the gun in its charging position on the bracket clamping guides (27). The wireless charging stand (28) has an area where the wireless charging transmitter is located and the gun has a flat area (29) where the receiver of the wireless charger is located, therefore, when the gun is resting on the stand, the batteries are charged.

1. Electronic pressure fluid dispensing gun with automatic locking mechanism characterised by incorporating a measuring chamber (8) of the volume transferred downstream of the control valve (6) and outside the pressure line. It also has an automatic locking mechanism which is located in the lower part of the gun, without interrupting the flow of pressurised fluid in such a way that the inlet and outlet of the fluid through the gun are on the longitudinal plane thereof without interrupting the flow of fluid under pressure in such a way that the fluid inlet and outlet through the gun are on the longitudinal plane of the gun and this same automatic valve locking mechanism automatically closes the control valve (6) when the quantity of fluid to be dispensed is reached. This prevents the dispensing of fluid unless a new dispensing order is validated in the gun's electronics module (9). This automatic locking mechanism consists of a manually operated trigger (5) which actuates a connecting rod (10) of particular design, hinged at one end by a pin (13) which joins it to a slide (12) which slides in a housing. The slide linked to the connecting rod (10) contacts a cam-shaped pawl (15), which is kept in contact with the slide (12) by a torsion spring (30), and will act independently of the stroke of the trigger (5), allowing the flow rate to be regulated without the need to lock the trigger (5) in an extreme position.
The electronic gun consists of:
a fluid inlet connection (1),
a handle (2) for easy handling,
an electronic control interface (3) for managing and entering the quantities of fluid to be dispensed,
a wireless battery recharging system on the gun comprising the receiver (29) and the charging station (28),
a manually operated trigger (5) for opening and closing the fluid flow valve (6), a measuring chamber (8) responsible for measuring the volume of fluid transferred and communicating it to the electronics module (9),
an outlet connection (4) to which a nozzle extension (7) is attached to prevent the dripping of fluid and to direct the fluid flow to the outlet and,
an automatic valve locking mechanism consisting of:
a valve (6),
a connecting rod (10),
a pin (11) that connects the valve (6) to the connecting rod (10) and slides along the groove (10a),
a slide (12),
a pin (13) connecting the connecting rod (10) to the slide (12),
a spring (14),
a cam pawl (15),
a torsion spring (30) and,
a solenoid (16) whose stem (16a) moves linearly by retracting and extending when receiving an electrical signal from the electronics module (9).

2. Electronic pressurised fluid dispensing gun with automatic locking mechanism according to the first claim, characterised in that the automatic locking mechanism of the valve (6), which is not intrusive with regards the fluid outlet flow, automatically closes the valve (6) when the quantity of fluid to be dispensed, pre-set in the electronics module (9), is reached.

3. Electronic pressurised fluid dispensing gun with automatic locking mechanism according to the first claim, characterised in that the valve locking mechanism (6) consists of a manually operated trigger (5) which actuates a connecting rod (10) of particular design, articulated at one of its ends by means of a pin (13) which joins it to a slide (12) which slides along a housing. The connecting rod (10) has at the other end a groove (10a) through which slides a pin (11) attached to the end of the valve (6) that opens and closes the passage of the fluid. The slide (12) is held in its extreme position by a spring (14) which returns it to its initial position when the force on the trigger (5) is released. When no external force is exerted, the valve (6) is maintained in the closed position in the fluid flow by the action of the valve spring (24).

4. Electronic pressurised fluid dispensing gun with automatic locking mechanism according to the third claim, characterised in that the slide described (12) and connected to the connecting rod (10) contacts a cam-shaped pawl (15), which is kept in contact with the slide (12) by a torsion spring (30), the movement of which can be limited by the extension of a rod (16a) actuated by a solenoid (16) which receives an electrical signal from the electronics module (9) with which the user interacts.

5. Electronic pressurised fluid dispensing gun with automatic locking mechanism according to the fourth claim, characterised in that the trigger (5) can be kept locked without manual intervention, in the dispensing position with the valve (6) open, by means of a button (21) integrated in the trigger itself (5), which engages with a pin (22) integrated in the body of the gun.

6. Electronic pressurised fluid dispensing gun with automatic locking mechanism according to the first claim, characterised in that the electronics module (9) can have wireless communication for connection with other management systems external to the gun.
